(19) United States
(12) Patent Application Publication
(10) Pub. No.: US 2016/0318146 A1
(43) Pub. Date: Nov. 3, 2016

(54) APPARATUS FOR BUFFING A PIPE ASSEMBLY

(71) Applicants: Derek KOSTIUK, Drayton Valley (CA); Lee ELLIOTT, Rocky Rapids (CA)

(72) Inventors: Derek KOSTIUK, Drayton Valley (CA); Lee ELLIOTT, Rocky Rapids (CA)

(21) Appl. No.: 14/700,362

(22) Filed: Apr. 30, 2015

(51) Int. Cl. B24B 5/40; B24B 23/02; B08B 9/027; B08B 9/02; B08B 9/023

(52) U.S. Cl. CPC B24B 5/40; B08B 9/021; B08B 9/023; B08B 9/027; B24B 23/02

(57) ABSTRACT

An apparatus is for a pipe assembly having an open-ended pipe portion with a pipe end face extending between an inner pipe diameter and an outer pipe diameter. The apparatus includes a support assembly configured to be spatially positioned and movable. A buffing assembly is configured to extend from the support assembly. This is done in such a way that the buffing assembly, in use, contacts the pipe end face, the inner pipe diameter and the outer pipe diameter of the open-ended pipe portion of the pipe assembly once the support assembly is spatially positioned. The buffing assembly is also configured to buff the pipe end face, the inner pipe diameter and the outer pipe diameter of the open-ended pipe portion of the pipe assembly.

### TECHNICAL FIELD

This document relates to the technical field of (and is not limited to) an apparatus for buffing a pipe assembly (and a method thereof).

### BACKGROUND

Pipe cleaning tools (such as buffing wheels) are configured to buff (clean) a pipe end section.

### SUMMARY

It will be appreciated that there exists a need to mitigate (at least in part) at least one problem associated with existing pipe cleaning tools (also called existing technology). After much study of the known systems and methods with experimentation, an understanding of the problem and its solution has been identified and is articulated as follows:

Conventional (known) pipe cleaning and/or buffing tools and methods may result in buckling of the pipe, etc., in such a way that the pipe buffing (cleaning) operation may be somewhat dangerous for the operator.

It is desirable to provide a solution in which the buffing operation is cleaner and relatively quicker, and saves time and money.

It is also desirable to provide a solution in which the buffing operation is relatively safer so less safety supervision and fewer skilled operators may be used, thus saving time and money while increasing worker safety.

To mitigate, at least in part, at least one problem associated with the existing technology, there is provided (in accordance with a first major aspect) an apparatus. The apparatus is for a pipe assembly having an open-ended pipe portion with a pipe end face extending between an inner pipe diameter and an outer pipe diameter. The apparatus includes a support assembly configured to be spatially positioned and movable, in use, relative to the open-ended pipe portion of the pipe assembly. A buffing assembly is configured to extend, in use and at least in part, from the support assembly. This is done in such a way that the buffing assembly (in use) contacts, at least in part, the pipe end face, the inner pipe diameter and the outer pipe diameter of the open-ended pipe portion of the pipe assembly once the support assembly is spatially positioned (in use) to do just so. The buffing assembly is also configured to buff, in use and at least in part, the pipe end face, the inner pipe diameter and the outer pipe diameter of the open-ended pipe portion of the pipe assembly once the buffing assembly is extended to do just so and in response to the movement of the support assembly.

To mitigate, at least in part, at least one problem associated with existing technology, there is provided (in accordance with a second major aspect) an apparatus. The apparatus is for a pipe assembly having an open-ended pipe portion with a pipe end face extending between an inner pipe diameter and an outer pipe diameter. The apparatus includes a support assembly configured to be spatially positioned and movable. A buffing assembly is configured to extend from the support assembly, and buff the pipe end face, the inner pipe diameter and the outer pipe diameter of the open-ended pipe portion of the pipe assembly once the buffing assembly is extended from the support assembly and in response to the movement of the support assembly.

Other aspects are identified in the claims.

Other aspects and features of the non-limiting embodiments may now become apparent to those skilled in the art upon review of the following detailed description of the non-limiting embodiments with the accompanying drawings.

### BRIEF DESCRIPTION OF THE DRAWINGS

The non-limiting embodiments may be more fully appreciated by reference to the following detailed description of the non-limiting embodiments when taken in conjunction with the accompanying drawings, in which:

FIG. 1A, FIG. 1B and FIG. 1C (SHEETS 1 and 2 of 6 SHEETS) depict views of embodiments of an apparatus for a pipe assembly;

FIG. 1D (SHEET 2 of 6 SHEETS) depicts an end view of the pipe assembly of any one of FIG. 1A, FIG. 1B and FIG. 1C;

FIG. 2A and FIG. 2B (SHEET 3 of 6 SHEETS) depict views of embodiments of the apparatus of any one of FIG. 1A and FIG. 1B;

FIG. 3A, FIG. 3B and FIG. 3C (SHEET 4 of 6 SHEETS) depict views of embodiments of the apparatus of any one of FIG. 1A and FIG. 1B; and

FIG. 4A, FIG. 4B and FIG. 4C (SHEETS 5 and 6 of 6 SHEETS) depict views of embodiments of the apparatus of any one of FIG. 1A and FIG. 1B.

The drawings are not necessarily to scale and may be illustrated by phantom lines, diagrammatic representations and fragmentary views. In certain instances, details unnecessary for an understanding of the embodiments (and/or details that render other details difficult to perceive) may have been omitted.

Corresponding reference characters indicate corresponding components throughout the several figures of the drawings. Elements in the several figures are illustrated for simplicity and clarity and have not been drawn to scale. The dimensions of some of the elements in the figures may be emphasized relative to other elements for facilitating an understanding of the various disclosed embodiments. In addition, common, but well-understood, elements that are useful or necessary in commercially feasible embodiments are often not depicted to provide a less obstructed view of the embodiments of the present disclosure.

### LISTING OF REFERENCE NUMERALS USED IN THE DRAWINGS

100 apparatus
102 support assembly
103 longitudinal axis
104 buffing assembly
106 shaft assembly
108 pipe gap
110 centrally aligned extension member
112 tapered portion
114 protection assembly
116 parallel-aligned sidewalls
118 tapered sidewalls
120 handle section
800 motorized tool
802 user
900 pipe assembly
902 open-ended pipe portion
904 pipe end face
906 inner pipe diameter
908 outer pipe diameter

### DETAILED DESCRIPTION OF THE EXEMPLARY EMBODIMENTS

The following detailed description is merely exemplary and is not intended to limit the described embodiments or the application and uses of the described embodiments. As used, the word “exemplary” or “illustrative” means “serving as an example, instance, or illustration.” Any implementation described as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure. The scope of the invention is defined by the claims. For the description, the terms “upper,” “lower,” “left,” “rear,” “right,” “front,” “vertical,” “horizontal,” and derivatives thereof shall relate to the examples as oriented in the drawings. There is no intention to be bound by any expressed or implied theory in the preceding Technical Field, Background, Summary or the following detailed description. It is also to be understood that the devices and processes illustrated in the attached drawings, and described in the following specification, are exemplary embodiments (examples), aspects and/or concepts defined in the appended claims. Hence, dimensions and other physical characteristics relating to the embodiments disclosed are not to be considered as limiting, unless the claims expressly state otherwise. It is understood that the phrase “at least one” is equivalent to “a”. The aspects (examples, alterations, modifications, options, variations, embodiments and any equivalent thereof) are described regarding the drawings. It should be understood that the invention is limited to the subject matter provided by the claims, and that the invention is not limited to the particular aspects depicted and described.

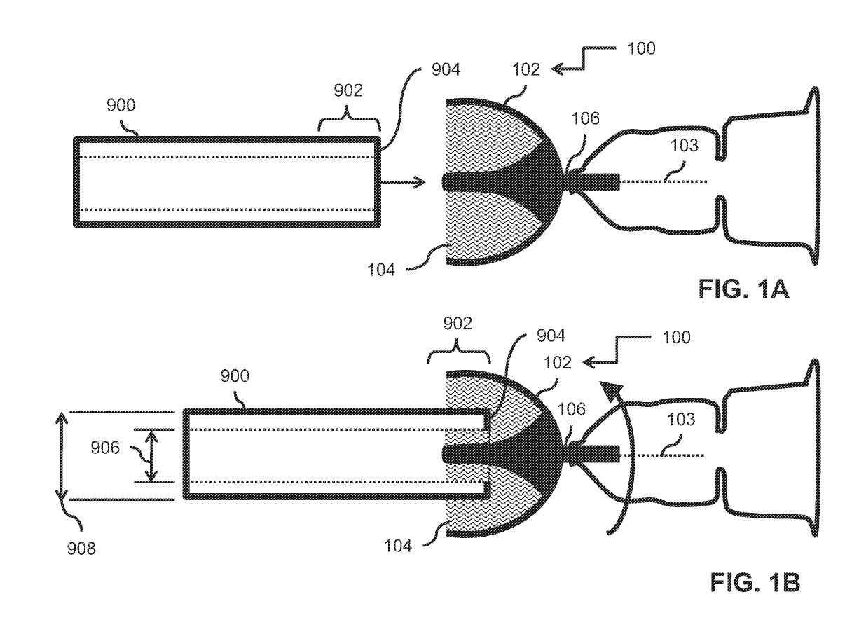

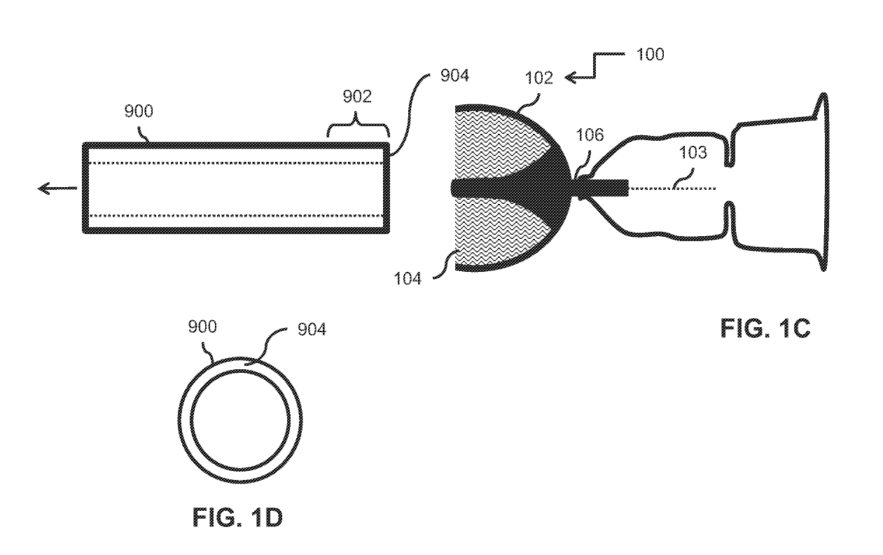

FIG. 1A, FIG. 1B and FIG. 1C depict views of embodiments of an apparatus 100 for a pipe assembly 900. FIG. 1A, FIG. 1B and FIG. 1C depict cross-sectional views of embodiments of the apparatus 100.

FIG. 1D depicts an end view of the pipe assembly 900 of any one of FIG. 1A, FIG. 1B and FIG. 1C.

Referring to the embodiments as depicted in FIG. 1A, FIG. 1B and FIG. 1C (and with reference to all of the FIGS.), the apparatus 100 is for the pipe assembly 900.

The pipe assembly 900 may include a tube of metal, plastic, or other suitable material used to convey water, gas, oil, or other type of fluid substance. The pipe assembly 900 has an open-ended pipe portion 902 with a pipe end face 904 extending between an inner pipe diameter 906 and an outer pipe diameter 908. The open-ended pipe portion 902 is also called a pipe end face portion or pipe face.

The apparatus 100 includes (and is not limited to) a synergistic combination of a support assembly 102 and a buffing assembly 104.

The support assembly 102 is configured to be spatially positioned and movable, in use, relative to the open-ended pipe portion 902 of the pipe assembly 900. The support assembly 102 may include any type of shaped support device. The support assembly 102 may be called a housing assembly. The buffing assembly 104 is configured to extend, in use and at least in part, from the support assembly 102. This is done in such a way that the buffing assembly 104 contacts, at least in part and in use, the pipe end face 904, the inner pipe diameter 906 and the outer pipe diameter 908 of the open-ended pipe portion 902 of the pipe assembly 900 once the support assembly 102 is spatially positioned, in use, to do just so. In addition, the buffing assembly 104 is also configured to buff, in use and at least in part, the pipe end face 904, the inner pipe diameter 906 and the outer pipe diameter 908 of the open-ended pipe portion 902 of the pipe assembly 900 once the buffing assembly 104 is extended to do just so and in response to the movement of the support assembly 102.

A technical effect of the combination of the support assembly 102 and the buffing assembly 104 is that the open-ended pipe portion 902 may extend so far into the buffing assembly 104 in such a way that once the buffing assembly 104 is reciprocated (moved) back and forth several times (such as, once or twice), the open-ended pipe portion 902 is cleaned, at least in part, by the buffing assembly 104.

It will be appreciated that the support assembly 102 and the buffing assembly 104 may be configured or adapted to suit any type of the pipe assembly 900 (to accommodate most sizes of pipes or pipelines). Preferably, the apparatus 100 is used in a single pass (application to the open-ended pipe portion 902 as depicted in FIG. 1B). The apparatus 100 cleans (in use) the pipe assembly 900. The apparatus 100 is configured to improve the safety of the user. The user (operator) may use the apparatus 100 to buff (in use) the open-ended pipe portion 902 (as depicted above), preferably in one shot (application or use of the apparatus 100). Preferably, the support assembly 102 and the buffing assembly 104 are configured to prevent (at least in part) bucking and binding of the open-ended pipe portion 902.

For instance, the buffing assembly 104 includes buffing elements, such as wire bristles and/or steel wires (and any equivalent thereof), that extend (fixedly extend) from the support assembly 102. The steel wires may be configured to be fixedly mounted to the support assembly 102, and to extend from the support assembly 102 into the interior of the support assembly 102. For instance, the wire bristles may include any one of brass wires, softened brass wires, a more malleable metal alloy (metallic wire bristles), plastic wires (plastic materials), and a cloth material (cloth materials), etc., and any equivalent thereof.

Preferably, the support assembly 102 is shaped as a semi-circular spheroid having an open end configured to receive, at least in part, the open-ended pipe portion 902 (as depicted in FIG. 1B). Preferably, the buffing assembly 104 is encased within the support assembly 102 in such a way that the elements of the buffing assembly 104 are not prone to inadvertently detaching from and becoming expelled from the interior of the support assembly 102 during normal operation of the buffing assembly 104.

In accordance with an embodiment, the apparatus 100 further includes a shaft assembly 106. The shaft assembly 106 is configured to be moved (rotated). The shaft assembly 106 has a longitudinal axis 103 extending along the shaft assembly 106. The support assembly 102 extends from the shaft assembly 106 in such a way that the support assembly 102 is movable in response to the movement of the shaft assembly 106.

Referring to the embodiments as depicted in FIG. 1A, FIG. 1B and FIG. 1C, there is depicted a method for buffing the pipe assembly 900. The method includes (and is not limited to) an operation for spatially positioning a support assembly 102 relative to the open-ended pipe portion 902 of the pipe assembly 900. The method also includes an operation for extending a buffing assembly 104, at least in part, from the support assembly 102 in such a way that the buffing assembly 104 contacts, at least in part and in use, the pipe end face 904, the inner pipe diameter 906 and the outer pipe diameter 908 of the open-ended pipe portion 902 of the pipe assembly 900 once the support assembly 102 is spatially positioned, in use, to do just so. The method also includes an operation for moving the support assembly 102 relative to the open-ended pipe portion 902 of the pipe assembly 900. The method also includes an operation for using the buffing assembly 104 to buff, at least in part, the pipe end face 904, the inner pipe diameter 906 and the outer pipe diameter 908 of the open-ended pipe portion 902 of the pipe assembly 900 once the buffing assembly 104 is extended to do just so and in response to the movement of the support assembly 102.

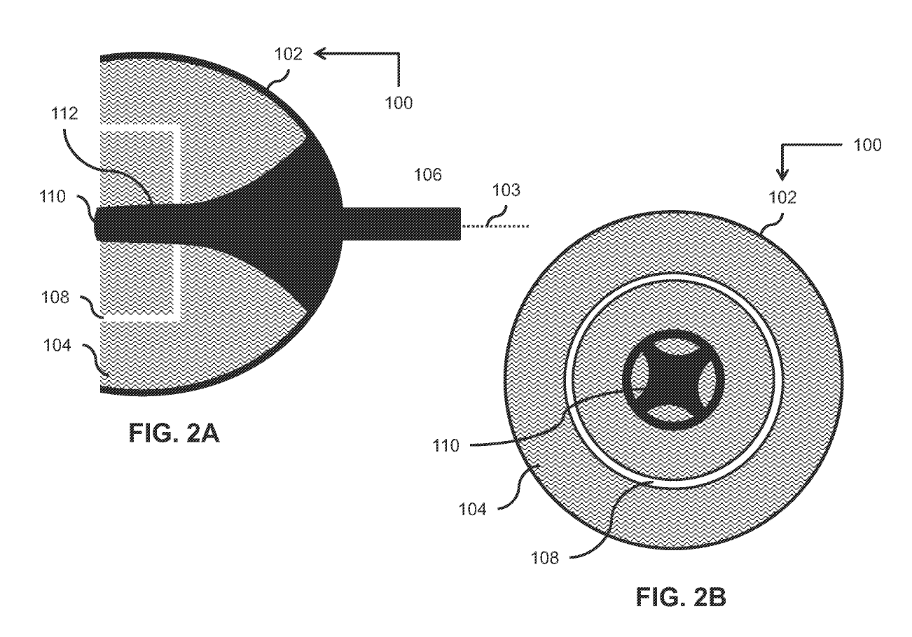

FIG. 2A and FIG. 2B depict views of embodiments of the apparatus 100 of any one of FIG. 1A and FIG. 1B. FIG. 2A depicts a cross-sectional view of an embodiment of the support assembly 102. FIG. 2B depicts an end view of an embodiment of the support assembly 102 (looking into the interior of the support assembly 102).

Referring to the embodiment as depicted in FIG. 2A, the apparatus 100 further includes a centrally aligned extension member 110 fixedly extending from the support assembly 102. The centrally aligned extension member 110 is spatially positioned, at least in part, in the support assembly 102. Preferably, the longitudinal axis 103 of the shaft assembly 106 is coaxially aligned with the centrally aligned extension member 110. Preferably, the centrally aligned extension member 110 is configured to be screwed (operatively attached) into the support assembly 102.

Preferably, the centrally aligned extension member 110 includes a tapered portion 112. The tapered portion 112 is configured to assist in imparting (in use) a buffing force to the open-ended pipe portion 902 (as depicted in FIG. 1B)

Referring to the embodiment as depicted in FIG. 2A and FIG. 2B, the buffing assembly 104 is configured to form a pipe gap 108 positioned between the elements of the buffing assembly 104 (such as, between the steel wires). The pipe gap 108 is configured to receive, at least in part, the pipe end face 904 of the pipe assembly 900. This is done in such a way that the pipe end face 904 is relatively easier to be inserted into the buffing assembly 104 via the pipe gap 108 (especially so for the case where the buffing assembly 104 includes steel wires). For this embodiment, a portion of the buffing assembly 104 extends radially outward (relative to the longitudinal axis 103) from a distal end portion of the centrally aligned extension member 110. Another portion of the buffing assembly 104 extends radially inward (relative to the longitudinal axis 103) from opposite sides walls of the support assembly 102 positioned proximate to the entranceway leading into the interior of the support assembly 102. Preferably, the pipe gap 108 is configured to receive, at least in part, the sidewalls extending from the open-ended pipe portion 902 (as depicted in FIG. 1B).

In accordance with the embodiments as depicted in FIGS. 2A and 2B, the open-ended pipe portion 902 may extend so far into the buffing assembly 104 in such a way that once the buffing assembly 104 is reciprocated (moved) back and forth several times (such as, twice), the open-ended pipe portion 902 is cleaned by the buffing assembly 104.

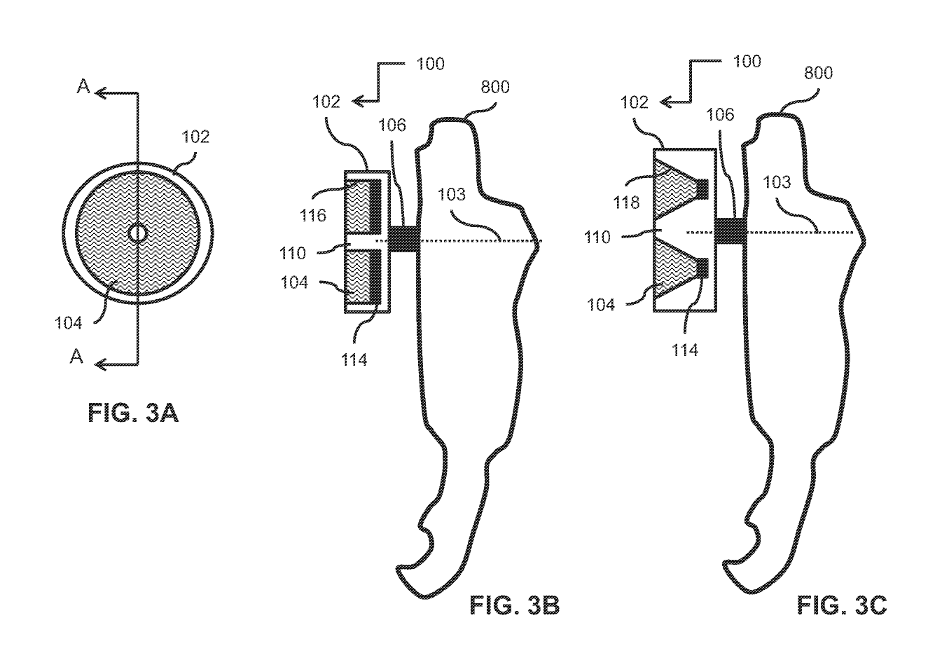

FIG. 3A, FIG. 3B and FIG. 3C depict views of embodiments of the apparatus 100 of any one of FIG. 1A and FIG. 1B. FIG. 3A depicts an end view of an embodiment of the support assembly 102 (looking into the interior of the support assembly 102). FIG. 3B and FIG. 3C depict cross-sectional views of embodiments of the support assembly 102.

Referring to the embodiment as depicted in FIG. 3B and FIG. 3C, the shaft assembly 106 is configured to be operatively mounted to a motorized tool 800 (such as a hand-held rotatable tool). The motorized tool 800 is configured to be rotated once energized to do just so. In this manner, the shaft assembly 106 may be rotated to move so that the support assembly 102 and the buffing assembly 104 may be rotated as well. This is done in such a way that once the open-ended pipe portion 902 (as depicted in FIG. 1B) is inserted, at least in part, into the interior of the buffing assembly 104, the open-ended pipe portion 902 may be buffed (cleaned) as described above.

Referring to the embodiment as depicted in FIG. 3B and FIG. 3C, the apparatus 100 further includes a protection assembly 114 fixedly positioned within the support assembly 102. The protection assembly 114 is configured to protect the open-ended pipe portion 902 (as depicted in FIG. 1A) in such a way that once the open-ended pipe portion 902 enters the interior of the support assembly 102, the open-ended pipe portion 902 may strike the protection assembly 114 and the open-ended pipe portion 902 does not become inadvertently damaged (wrecked) as a result of entering too far into the interior of the support assembly 102.

Referring to the embodiment as depicted in FIG. 3A, the support assembly 102 defines parallel-aligned sidewalls 116 that are aligned coaxially with the longitudinal axis 103 (that is, are aligned parallel relative to the longitudinal axis 103). The technical effect of the parallel-aligned sidewalls 116 is to prolong the operative life of the buffing assembly 104.

Referring to the embodiment as depicted in FIG. 3B, the support assembly 102 defines tapered sidewalls 118. More specifically, the tapered sidewalls 118 are aligned non-coaxially with the longitudinal axis 103 (that is, are not aligned parallel relative to the longitudinal axis 103). The technical effect of the tapered sidewalls 118 is to prolong the operative life of the buffing assembly 104.

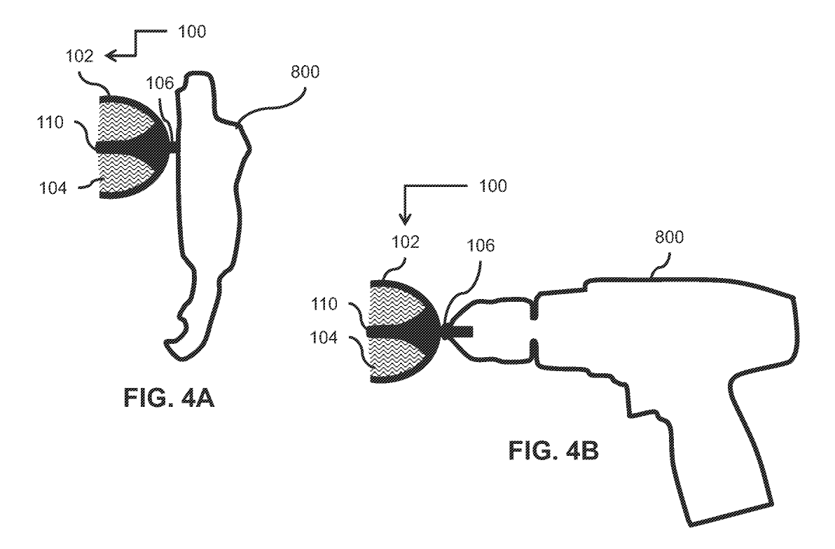

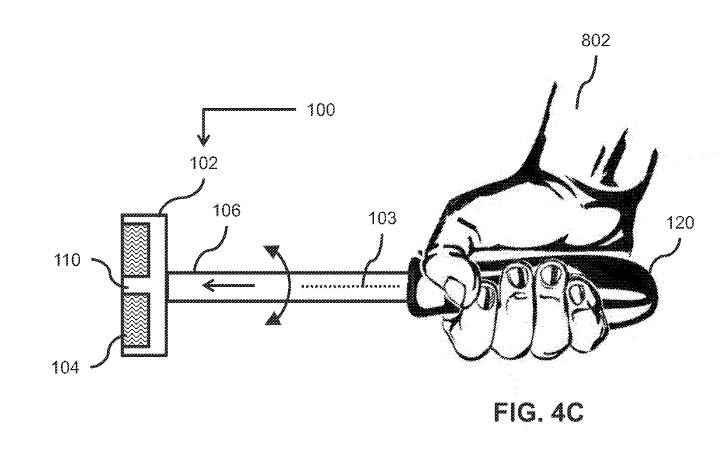

FIG. 4A, FIG. 4B and FIG. 4C depict views of embodiments of the apparatus 100 of any one of FIG. 1A and FIG. 1B. FIG. 4A, FIG. 4B and FIG. 4C depict cross-sectional views of embodiments of the support assembly 102.

It will be appreciated that there are many ways to configure the support assembly 102 and the buffing assembly 104.

Referring to the embodiment as depicted in FIG. 4A, the shaft assembly 106 is configured to be attached to the motorized tool 800, such as a grinding tool having a chuck assembly configured to receive the shaft assembly 106 of the apparatus 100.

Referring to the embodiment as depicted in FIG. 4B, the shaft assembly 106 is configured to be attached to the motorized tool 800, such as a drilling tool having a chuck assembly configured to receive the shaft assembly 106 of the apparatus 100.

Referring to the embodiment as depicted in FIG. 4C, the shaft assembly 106 includes a handle section 120 configured to be manipulated (rotated) by the user 802, without the use of a motorized unit.

This written description uses examples to disclose the invention, including the best mode, and also to enable any person skilled in the art to make and use the invention. The patentable scope of the invention is defined by the claims, and may include other examples that occur to those skilled in the art. Such other examples are within the scope of the claims if they have structural elements that do not differ from the literal language of the claims, or if they include equivalent structural elements with insubstantial differences from the literal language of the claims.

It may be appreciated that the assemblies and modules described above may be connected with each other as required to perform desired functions and tasks within the scope of persons of skill in the art to make such combinations and permutations without having to describe each and every one in explicit terms. There is no particular assembly or component that may be superior to any of the equivalents available to the person skilled in the art. There is no particular mode of practicing the disclosed subject matter that is superior to others, so long as the functions may be performed. It is believed that all the crucial aspects of the disclosed subject matter have been provided in this document. It is understood that the scope of the present invention is limited to the scope provided by the independent claim(s), and it is also understood that the scope of the present invention is not limited to: (i) the dependent claims, (ii) the detailed description of the non-limiting embodiments, (iii) the summary, (iv) the abstract, and/or (v) the description provided outside of this document (that is, outside of the instant application as filed, as prosecuted, and/or as granted). It is understood, for this document, that the phrase “includes” is equivalent to the word “comprising.” The foregoing has outlined the non-limiting embodiments (examples). The description is made for particular non-limiting embodiments (examples). It is understood that the non-limiting embodiments are merely illustrative as examples.

What is claimed is:

1. An apparatus for a pipe assembly having an open-ended pipe portion with a pipe end face extending between an inner pipe diameter and an outer pipe diameter, the apparatus comprising:
a support assembly being configured to be spatially positioned and movable; and
a buffing assembly being configured to:
extend from the support assembly; and
buff the pipe end face, the inner pipe diameter and the outer pipe diameter of the open-ended pipe portion of the pipe assembly once the buffing assembly is extended from the support assembly and in response to movement of the support assembly.

2. An apparatus for a pipe assembly having an open-ended pipe portion with a pipe end face extending between an inner pipe diameter and an outer pipe diameter, the apparatus comprising:
a support assembly being configured to be spatially positioned and movable, in use, relative to the open-ended pipe portion of the pipe assembly; and
a buffing assembly being configured to:
extend, in use and at least in part, from the support assembly in such a way that the buffing assembly, in use, contacts, at least in part and in use, the pipe end face, the inner pipe diameter and the outer pipe diameter of the open-ended pipe portion of the pipe assembly once the support assembly is spatially positioned, in use, to do just so; and
buff, in use and at least in part, the pipe end face, the inner pipe diameter and the outer pipe diameter of the open-ended pipe portion of the pipe assembly once the buffing assembly is extended to do just so and in response to movement of the support assembly.

3. The apparatus of claim 2, further comprising:
a shaft assembly being configured to be moved (rotated), the shaft assembly having a longitudinal axis extending along the shaft assembly; and
the support assembly extending from the shaft assembly in such a way that the support assembly is movable in response to movement of the shaft assembly.

4. The apparatus of claim 2, wherein:
the support assembly and the buffing assembly are configured to prevent (at least in part) bucking and binding of the open-ended pipe portion.

5. The apparatus of claim 2, wherein:
the buffing assembly includes:
wire bristles fixedly extending from the support assembly, and the wire bristles are configured to be fixedly mounted of the support assembly, and to extend from the support assembly into the interior of the support assembly.

6. The apparatus of claim 2, wherein:
the buffing assembly includes any one of metallic wire bristles, plastic wires and a cloth material.

7. The apparatus of claim 2, wherein:
the support assembly is shaped as a semi-circular spheroid having an open end configured to receive, at least in part, the open-ended pipe portion.

8. The apparatus of claim 2, wherein:
the buffing assembly is encased within the support assembly in such a way that elements of the buffing assembly are not prone to inadvertently detaching from and becoming expelled from the interior of the support assembly during normal operation of the buffing assembly.

9. The apparatus of claim 3, further comprising:
a centrally aligned extension member fixedly extending from the support assembly;
the centrally aligned extension member is spatially positioned, at least in part, in the support assembly; and
the longitudinal axis of the shaft assembly is coaxially aligned with the centrally aligned extension member.

10. The apparatus of claim 9, wherein:
the centrally aligned extension member includes a tapered portion; and
the tapered portion is configured to assist in imparting, in use, a buffing force to the open-ended pipe portion.

11. The apparatus of claim 2, wherein:
the buffing assembly is configured to form a pipe gap positioned between elements of the buffing assembly;
the pipe gap is configured to receive, at least in part, the pipe end face of the pipe assembly in such a way that the pipe end face is relatively easier to be inserted into the buffing assembly via the pipe gap.

12. The apparatus of claim 10, wherein:
a portion of the buffing assembly extends radially outward relative to the longitudinal axis from a distal end portion of the centrally aligned extension member; and
another portion of the buffing assembly extends radially inward relative to the longitudinal axis from opposite sides walls of the support assembly positioned proximate to an entranceway leading into the interior of the support assembly.

13. The apparatus of claim 11, wherein:
the pipe gap is configured to receive, at least in part, sidewalls extending from the open-ended pipe portion.

14. The apparatus of claim 3, wherein:
the shaft assembly is configured to be operatively mounted to a motorized tool configured to be rotated once energized to do just so.

15. The apparatus of claim 3, further comprising:
a protection assembly being fixedly positioned within the support assembly;
the protection assembly being configured to protect the open-ended pipe portion in such a way that once the open-ended pipe portion enters the interior of the support assembly, the open-ended pipe portion may strike the protection assembly and the open-ended pipe portion does not become inadvertently damaged (wrecked) as a result of entering too far into the interior of the support assembly.

16. The apparatus of claim 3, wherein:
the support assembly defines parallel-aligned sidewalls that are aligned coaxially with the longitudinal axis of the shaft assembly.

17. The apparatus of claim 3, wherein:
the support assembly defines tapered sidewalls aligned non-coaxially with the longitudinal axis of the shaft assembly.

18. The apparatus of claim 3, wherein:
the shaft assembly is configured to be attached to a motorized tool having a chuck assembly configured to receive the shaft assembly.

19. The apparatus of claim 3, wherein:
the shaft assembly includes a handle section configured to be user manipulated.

20. A method for buffing a pipe assembly having an open-ended pipe portion with a pipe end face extending between an inner pipe diameter and an outer pipe diameter, the method comprising:
spatially positioning a support assembly relative to the open-ended pipe portion of the pipe assembly; and
extending a buffing assembly, at least in part, from the support assembly in such a way that the buffing assembly, in use contacts, at least in part, the pipe end face, the inner pipe diameter and the outer pipe diameter of the open-ended pipe portion of the pipe assembly once the support assembly is spatially positioned, in use, to do just so;
moving the support assembly relative to the open-ended pipe portion of the pipe assembly; and
using the buffing assembly to buff, at least in part, the pipe end face, the inner pipe diameter and the outer pipe diameter of the open-ended pipe portion of the pipe assembly once the buffing assembly is extended to do just so and in response to movement of the support assembly.
